(19) United States
(12) Patent Application Publication
(10) Pub. No.: US 2025/0132361 A1
(43) Pub. Date: Apr. 24, 2025

(54) FLOW BATTERY SYSTEM, BATTERY MONITORING DEVICE THEREOF, AND ELECTRODE ELEMENT FOR BATTERY MONITORING DEVICE AND MANUFACTURING METHOD THEREOF

(71) Applicant: INDUSTRIAL TECHNOLOGY RESEARCH INSTITUTE, HSINCHU (TW)

(72) Inventors: Chih-Hsing LEU, Hsinchu County (TW); Cyun-Jie HUANG, Tainan City (TW); Chih-Hung LIN, Tainan City (TW)

(21) Appl. No.: 18/594,001

(22) Filed: Mar. 4, 2024

(30) Foreign Application Priority Data
Oct. 18, 2023 (TW) 112139849

(51) Int. Cl. H01M 8/04537; H01M 4/75; H01M 4/76; H01M 4/88; H01M 8/0276; H01M 8/04082; H01M 8/18

(52) U.S. Cl. CPC H01M 8/04544; H01M 4/75; H01M 4/765; H01M 8/0278; H01M 8/04201; H01M 8/188; H01M 4/88

(57) ABSTRACT

The present disclosure discloses a flow battery system, a battery monitoring device for the flow battery system, and an electrode element for the battery monitoring device and a manufacturing method thereof. The battery monitoring device includes a positive end plate, a positive electrode element, a negative end plate, a negative electrode element, electrolyte supply channels, electrolyte discharge channels, a separator, and a voltage measurement unit. The positive electrode element penetrates through the positive end plate and includes an electrode rod and a signal transmission portion that protrudes from an outer surface of the positive end plate. The negative electrode element penetrates through the negative end plate and includes an electrode rod and a signal transmission portion that is projected on an outer surface of the negative end plate. The separator is between the positive end plate and the negative end plate.

### CROSS-REFERENCE TO RELATED APPLICATION

The present application is based on, and claims priority from, Taiwan Application Serial Number 112139849, filed Oct. 18, 2023, the disclosure of which is hereby incorporated by reference herein in its entirety.

### BACKGROUND

### Field of Invention

The present disclosure relates to a flow battery system, a battery monitoring device for the flow battery system, an electrode element for the battery monitoring device, and a manufacturing method of the electrode element.

### Description of Related Art

Flow batteries have the advantages of good charge and discharge performance, recyclability properties, long service life, and convenient maintenance, so they are ideal energy storage devices. In addition, the products of the flow batteries during the manufacturing, use, and disposal processes can be completely recycled and reused, so they have the advantage of being environmentally friendly. When using a flow battery, if the user can accurately know the battery capacity, the battery capacity can be effectively utilized, and the charge and discharge of the flow battery can be more accurately controlled to achieve maximum battery capacity and extend the service life of the flow battery. Given the above, there is an urgent need to develop a new device for measuring the battery capacity of flow batteries.

### SUMMARY

The present disclosure provides a battery monitoring device for a flow battery system. The battery monitoring device includes a positive end plate, a positive electrode electrolyte supply channel, a positive electrode electrolyte discharge channel, a positive electrode element, a negative end plate, a negative electrolyte supply channel, a negative electrolyte discharge channel, a negative electrode element, a separator, and a voltage measurement unit. The positive end plate defines a first chamber. The positive electrode electrolyte supply channel and the positive electrode electrolyte discharge channel respectively penetrate through the positive end plate to communicate with the first chamber. The positive electrode element penetrates through the positive end plate and corresponds to the first chamber, in which the positive electrode element includes a first electrode rod and a first signal transmission portion that are connected. The positive end plate has a first outer surface away from the first chamber, and the first signal transmission portion protrudes from the first outer surface. The negative end plate defines a second chamber. The negative electrolyte supply channel and the negative electrolyte discharge channel respectively penetrate through the negative end plate to communicate with the second chamber. The negative electrode element penetrates through the negative end plate and corresponds to the second chamber, in which the negative electrode element includes a second electrode rod and a second signal transmission portion that are connected. The negative end plate has a second outer surface far away from the second chamber, and the second signal transmission portion protrudes from the second outer surface. The separator is disposed between the first chamber and the second chamber.

The present disclosure provides a flow battery system including a flow battery unit, a positive electrolyte tank, a negative electrolyte tank, the battery monitoring device of any of the aforementioned embodiments, a first liquid supply pipeline, a second liquid supply pipeline, a first liquid discharge pipeline, and a second liquid discharge pipeline. The positive electrolyte tank stores a positive electrolyte and is coupled to the flow battery unit. The negative electrolyte tank stores a negative electrolyte and is coupled to the flow battery unit. The first liquid supply pipeline is coupled to the positive electrolyte tank and communicates with the positive electrolyte supply channel. The second liquid supply pipeline is coupled to the negative electrolyte tank and communicates with the negative electrolyte supply channel. The first liquid discharge pipeline communicates with the positive electrolyte discharge channel and is coupled to the positive electrolyte tank. The second liquid discharge pipeline communicates with the negative electrolyte discharge channel and is coupled to the negative electrolyte tank.

The present disclosure provides an electrode element for a battery monitoring device. The electrode element includes a signal transmission portion, an electrode rod, and an insulation tube. The electrode rod is connected to the signal transmission portion, in which the electrode rod is configured to measure an open circuit voltage of the battery monitoring device. The insulation tube covers a portion of the electrode rod, in which the insulation tube has a first end and a second end, and the first end is opposite to the second end. The electrode rod has a first protruding portion positioned outside the first end, and the signal transmission portion has a second protruding portion positioned outside the second end.

The present disclosure provides a manufacturing method for an electrode element of a battery monitoring device. The manufacturing method includes the following operations. An electrode rod is connected to a signal transmission portion, in which the electrode rod is configured to measure an open circuit voltage of the battery monitoring device. A portion of the electrode rod is putted through a tubular hole of the insulation tube, in which the insulation tube has a first end and a second end, the first end is opposite to the second end, and the electrode rod has a first protruding portion positioned outside the first end.

### BRIEF DESCRIPTION OF THE DRAWINGS

The present disclosure can be more fully understood by reading the following detailed description of the embodiments and referring to the accompanying drawings.

FIG. 1 is a schematic diagram of a flow battery system and a load according to the various embodiments of the present disclosure.

FIG. 2A and FIG. 2B are side views of a battery monitoring unit according to the various embodiments of the present disclosure.

FIG. 3A to FIG. 3B are side views of a positive end plate, a first liquid supply pipeline, and a first liquid discharge pipeline according to the various embodiments of the present disclosure.

FIG. 4A to FIG. 4B are side views of a negative end plate, a second liquid supply pipeline, and a second liquid discharge pipeline according to the various embodiments of the present disclosure.

FIG. 5A is a perspective view of a positive end plate according to the various embodiments of the present disclosure.

FIG. 5B is a perspective view of a negative end plate according to the various embodiments of the present disclosure.

FIG. 5C is a side view of a negative end plate according to the various embodiments of the present disclosure.

FIG. 6 to FIG. 8 are exploded schematic diagrams of a battery monitoring unit of a battery monitoring device according to the various embodiments of the present disclosure.

FIG. 9A to FIG. 9D and FIG. 10A to FIG. 10D are schematic cross-sectional views of electrode elements for a battery monitoring device according to the various embodiments of the present disclosure.

FIG. 11A to FIG. 11D are flow charts of manufacturing methods for electrode elements of battery monitoring devices according to the various embodiments of the present disclosure.

FIG. 12 is a voltage-time relationship diagram of a flow battery according to the various embodiments of the present disclosure.

FIG. 13 and FIG. 15 are voltage-time relationship diagrams of battery monitoring devices according to the various embodiments of the present disclosure.

FIG. 14 is a power-time relationship diagram of a flow battery according to the various embodiments of the present disclosure.

### DETAILED DESCRIPTION

The following embodiments are disclosed with accompanying diagrams for a detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, to simplify the drawings, some of the conventional structures and elements are shown with schematic illustrations.

In this document, it will be understood that the terms first, second, third, etc. are used to describe various elements, components, regions, layers, and/or sections. However, these elements, components, regions, layers, and/or sections should not be limited by these terms. These terms are only used to distinguish one element, component, region, layer, and/or section. Therefore, a first element, component, region, layer, and/or section in the following may also be termed as a second element, component, region, layer, and/or section without departing from the intention of the present disclosure.

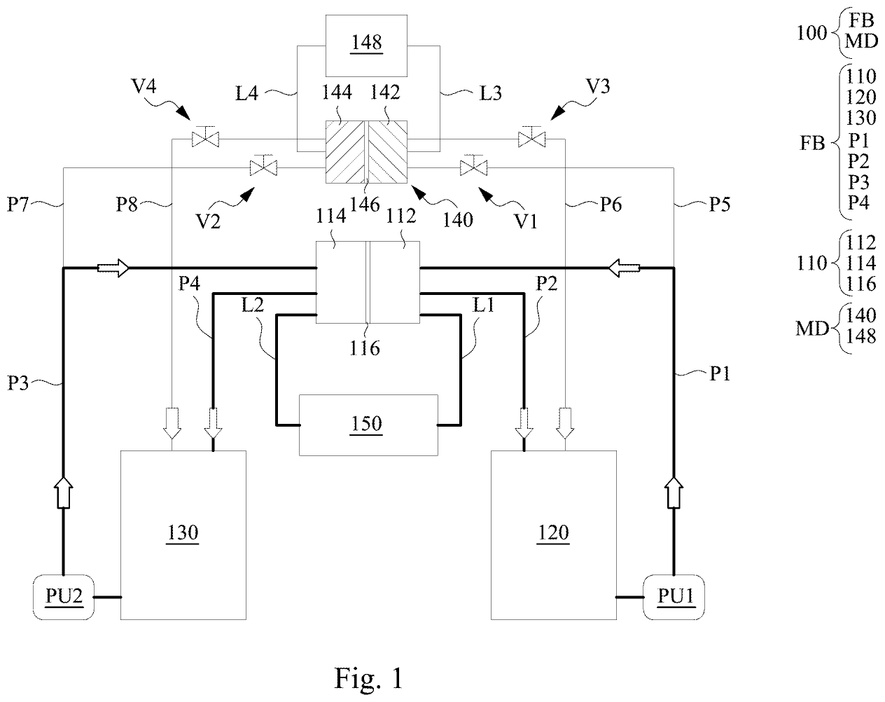

FIG. 1 is a schematic diagram of a flow battery system 100 and a load 150 according to the various embodiments of the present disclosure. The flow battery system 100 includes a flow battery FB and a battery monitoring device MD. The flow battery FB includes a flow battery unit 110, a positive electrolyte tank 120, a negative electrolyte tank 130, a first main liquid supply pipeline P1, a first main liquid discharge pipeline P2, a second main liquid supply pipeline P3, and a second main liquid discharge pipeline P4. The flow battery unit 110 includes a positive battery cell 112, a negative battery cell 114, and a separator 116. The separator 116 is disposed between the positive battery cell 112 and the negative battery cell 114. The load 150 is electrically connected to the positive battery cell 112 and the negative battery cell 114 of the flow battery unit 110 through a wire L1 and a wire L2 respectively. The flow battery system 100 can provide electricity to the load 150. The positive electrolyte tank 120 stores a positive electrolyte and is coupled to the flow battery unit 110. More specifically, the positive electrolyte tank 120 is coupled to the positive battery cell 112 to supply the positive electrolyte. In some embodiments, the positive electrolyte tank 120 is connected to the flow battery unit 110 through the first main liquid supply pipeline P1 and the first main liquid discharge pipeline P2. The first main liquid supply pipeline P1 is used to transport the positive electrolyte to the positive battery cell 112, and the first main liquid discharge pipeline P2 is used to release the positive electrolyte to the positive electrolyte tank 120. The negative electrolyte tank 130 stores a negative electrolyte and is coupled to the flow battery unit 110. More specifically, the negative electrolyte tank 130 is coupled to the negative battery cell 114 to supply the negative electrolyte. In some embodiments, the negative electrolyte tank 130 is connected to the flow battery unit 110 through the second main liquid supply pipeline P3 and the second main liquid discharge pipeline P4. The second main liquid supply pipeline P3 is used to transport the negative electrolyte to the negative battery cell 114, and the second main liquid discharge pipeline P4 is used to release the negative electrolyte to the negative electrolyte tank 130. In some embodiments, the flow battery FB is a vanadium flow battery (VFB), which can also be called a vanadium redox flow battery (VRFB). For example, the positive electrolyte contains VO₂⁺ and VO²⁺, and the negative electrolyte contains V³⁺ and V²⁺.

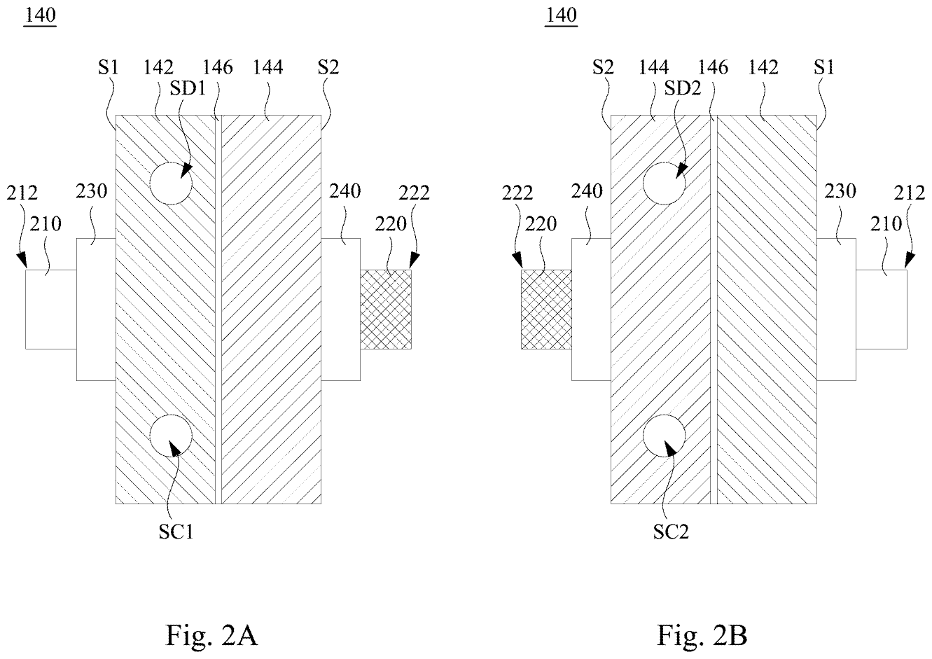

As shown in FIG. 1, the battery monitoring device MD includes a battery monitoring unit 140. The battery monitoring unit 140 includes a positive end plate 142, a negative end plate 144, and a separator 146. The separator 146 is disposed between the positive end plate 142 and the negative end plate 144. Other components of the battery monitoring unit 140 will be further described in subsequent FIG. 2A and FIG. 2B. A first liquid supply pipeline P5 and a first liquid discharge pipeline P6 are coupled to the positive electrolyte tank 120 and the battery monitoring unit 140, and a second liquid supply pipeline P7 and a second liquid discharge pipeline P8 are coupled to the negative electrolyte tank 130 and the battery monitoring unit 140. In some embodiments, the battery monitoring device MD further includes a voltage measurement unit 148. The voltage measurement unit 148 can be electrically connected to the battery monitoring unit 140 of the battery monitoring device MD through a wire L3 and a wire L4 to measure an open circuit voltage (OCV) of the battery monitoring unit 140, and then the battery capacity of the flow battery FB can be calculated from the open circuit voltage and the power of the flow battery FB. Therefore, the battery monitoring device MD can also be called a battery capacity measuring device.

As shown in FIG. 1, the first main liquid supply pipeline P1 communicates with the first liquid supply pipeline P5. In other words, the first liquid supply pipeline P5 is a branch pipeline of the first main liquid supply pipeline P1 and extends from the first main liquid supply pipeline P1. Therefore, a portion of the positive electrolyte flowing out from the positive electrolyte tank 120 will enter the battery monitoring unit 140. The second main liquid supply pipeline P3 communicates with the second liquid supply pipeline P7. In other words, the second main liquid supply pipeline P7 is a branch pipeline of the second main liquid supply pipeline P3, and extends from the second main liquid supply pipeline P3. Therefore, a portion of the negative electrolyte flowing out from the negative electrolyte tank 130 will enter the battery monitoring unit 140. In some embodiments, the pipeline diameters of the first main liquid supply pipeline P1 and the second main liquid supply pipeline P3 are respectively greater than the pipeline diameters of the first liquid supply pipeline P5 and the second liquid supply pipeline P7. The present disclosure is not limited to the embodiment shown in FIG. 1. In other embodiments, the first liquid supply pipeline P5 is directly connected to the positive electrolyte tank 120 (not shown), and the second liquid supply pipeline P7 is directly connected to the negative electrolyte tank 130 (not shown).

Please continue to refer to FIG. 1. A first pump PU1 delivers the positive electrolyte to the positive battery cell 112 and the battery monitoring unit 140. A second pump PU2 delivers the negative electrolyte to the negative battery cell 114 and the battery monitoring unit 140. The electrolytes mainly flow through the flow battery unit 110, and parts of the electrolytes enter the battery monitoring unit 140 of the battery monitoring device MD that measures the battery capacity. When the load 150 changes, this change may affect the voltage of flow battery FB, affecting a user to judge the battery capacity. However, the battery monitoring device MD can completely prevent the interference of charge, discharge, and load 150, and accurately measure the open circuit voltage, thereby accurately measuring the battery capacity of the flow battery FB. Therefore, a user can accurately control the charge and discharge of the flow battery FB, thereby extending the service life of the flow battery FB.

In some embodiments, the flow battery system 100 further includes at least one valve disposed on the first liquid supply pipeline P5, the first liquid discharge pipeline P6, the second liquid supply pipeline P7, the second liquid discharge pipeline P8, or combinations thereof. Please refer to FIG. 1. A first valve V1 is disposed on the first liquid supply pipeline P5, a second valve V2 is disposed on the second liquid supply pipeline P7, a third valve V3 is disposed on the first liquid discharge pipeline P6, and a fourth valve V4 is disposed on the second liquid discharge pipeline P8. In some embodiments, the first valve V1, the second valve V2, the third valve V3, and the fourth valve V4 are on-off valves, but are not limited thereto. The first valve V1 and the second valve V2 can be used to adjust the flow rates of the electrolytes. The third valve V3 and the fourth valve V4 can facilitate the user to repair and/or maintain the flow battery system 100.

Please refer to FIG. 1, FIG. 2A, and FIG. 2B at the same time. FIG. 2A and FIG. 2B are side views of the battery monitoring unit 140 according to the various embodiments of the present disclosure. As shown in FIG. 1, FIG. 2A, and FIG. 2B, the battery monitoring unit 140 of the battery monitoring device MD includes the positive end plate 142, the positive electrolyte supply channel SC1, the positive electrolyte discharge channel SD1, the positive electrode element 210, the negative end plate 144, the negative electrolyte supply channel SC2, the negative electrolyte discharge channel SD2, the negative electrode element 220, and the separator 146. The voltage measurement unit 148 shown in FIG. 1 is electrically connected to the positive electrode element 210 and the negative electrode element 220 shown in FIG. 2A or FIG. 2B to measure the open circuit voltage of the battery monitoring unit 140. In more detail, the positive electrode element 210 includes a first electrode rod (not shown) and a first signal transmission portion 212 that are connected, and the first signal transmission portion 212 protrudes from the first outer surface S1. The negative electrode element 220 includes a second electrode rod (not shown) and a second signal transmission portion 222 that are connected, and the second signal transmission portion 222 protrudes from the second outer surface S2. The voltage measurement unit 148 is electrically connected to the first signal transmission portion 212 and the second signal transmission portion 222. The first signal transmission portion 212 and the second signal transmission portion 222 are configured to connect with the voltage measurement unit 148 to transmit signals.

The first electrode rod and the second electrode rod (not shown) are configured to measure the open circuit voltage of the battery monitoring unit 140 of the battery monitoring device MD. Please refer to FIG. 1 and FIG. 2A at the same time. The first liquid supply pipeline P5 is coupled to the positive electrolyte tank 120 and communicates with the positive electrolyte supply channel SC1. The first liquid discharge pipeline P6 communicates with the positive electrolyte discharge channel SD1 and is coupled to the positive electrolyte tank 120. Please refer to FIG. 1 and FIG. 2B at the same time. The second liquid supply pipeline P7 is coupled to the negative electrolyte tank 130 and communicates with the negative electrolyte supply channel SC2. The second liquid discharge pipeline P8 communicates with the negative electrolyte discharge channel SD2 and is coupled to the negative electrolyte tank 130.

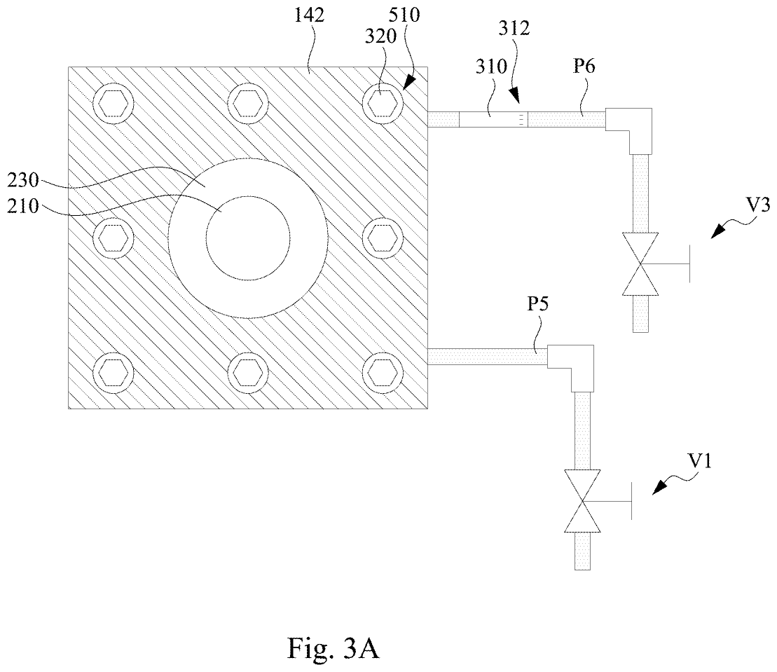

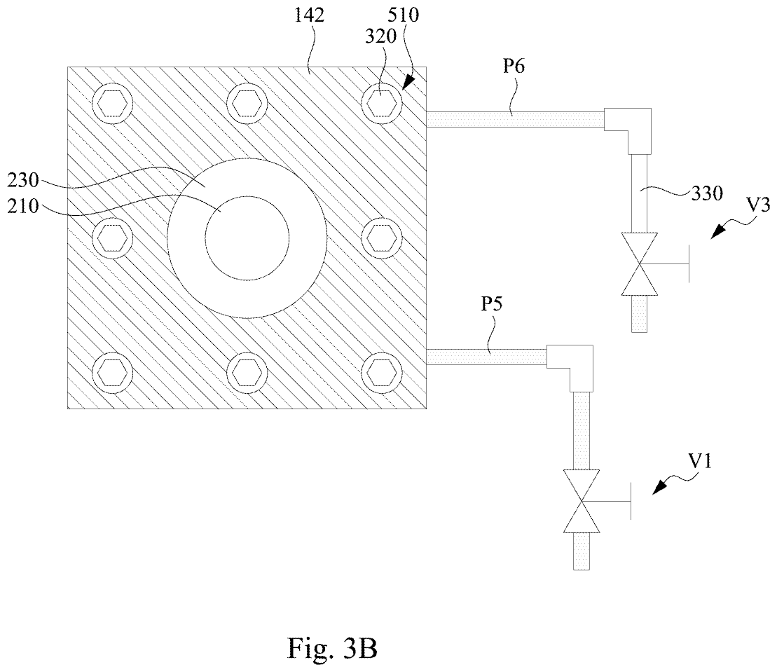

Please refer to FIG. 1 again. In some embodiments, at least one of the first liquid discharge pipeline P6 and the second liquid discharge pipeline P8 includes a transparent pipeline, so the user can clearly observe the liquid discharge amount and thereby adjust the liquid supply amount. In some embodiments, at least one of the above-mentioned pipelines is made of transparent material. FIG. 3A to FIG. 3B are side views of the positive end plate 142, the first liquid supply pipeline P5, and the first liquid discharge pipeline P6 according to the various embodiments of the present disclosure. As shown in FIG. 3A, the first liquid discharge pipeline P6 includes a transparent pipeline 310 that is substantially horizontal. In other words, at least a portion of the first liquid discharge pipeline P6 is transparent in the horizontal direction. Therefore, the user can directly and qualitatively observe the flow rate of the electrolyte and control the flow rate with the first valve V1 (such as an on-off valve). In addition, in some embodiments, the transparent pipeline 310 may be marked with a scale 312. When the flow rate of the electrolyte is higher, the liquid level corresponds to a higher scale. When the flow rate of the electrolyte is lower, the liquid level corresponds to a lower scale. Therefore, the user can semi-quantitatively observe the flow rate of the electrolyte and adjust the flow rate by adjusting the opening of first valve V1. The pipeline structure design of the present disclosure does not require disposing of additional expensive flow valves that can precisely control the flow rate. Instead, the on-off valves and the transparent pipelines that have simple structures allow the user to instantly observe the flow status and adjust the flow rate in real time. In addition, if a pipeline is blocked by a blockage, such as vanadium pentoxide, the user can immediately remove the blockage, thereby preventing distortion of the open-circuit voltage measurement.

In some embodiments, the first liquid supply pipeline P5 includes a non-horizontal transparent pipeline. For example, as shown in FIG. 3B, the first liquid discharge pipeline P6 includes a vertical transparent pipeline 330. In other words, at least a portion of the first liquid discharge pipeline P6 is transparent in the vertical direction, but the present disclosure is not limited thereto. Therefore, the user can directly and qualitatively observe the flow rate of the electrolyte and control the flow rate with the first valve V1 (such as an on-off valve). The pipeline structure design of the present disclosure does not require disposing of additional expensive flow valves that can precisely control the flow rate. Instead, the on-off valves and the transparent pipelines that have simple structures allow the user to instantly observe the flow status, adjust the flow rate, and remove a blockage in the transparent pipelines.

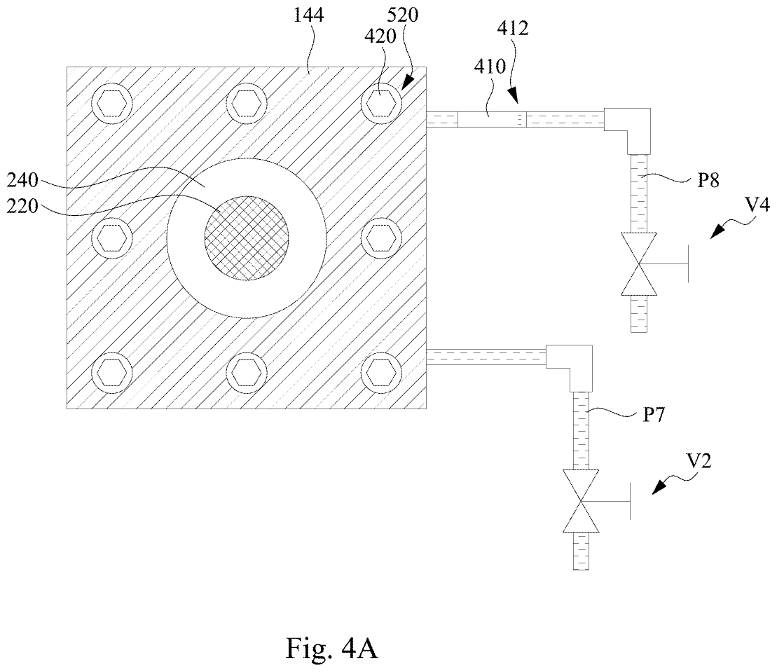

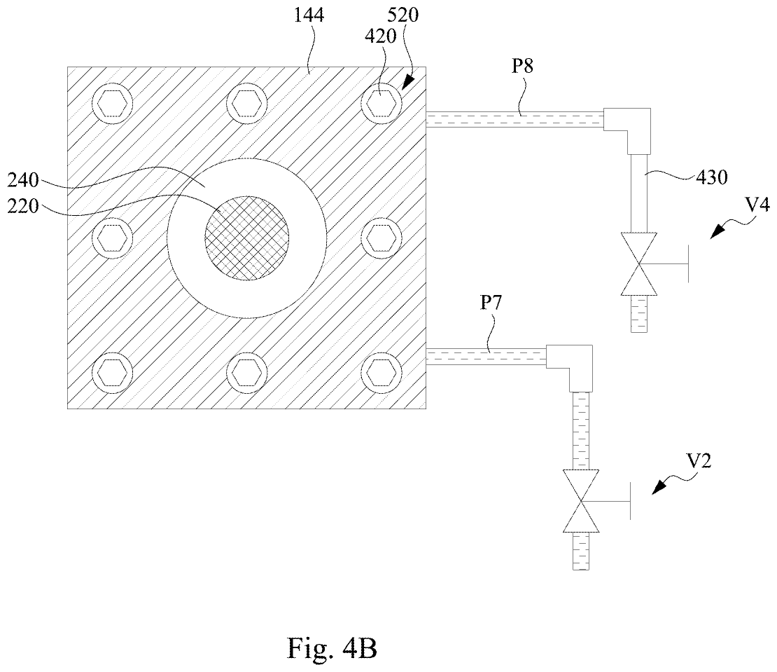

FIG. 4A to FIG. 4B are side views of the negative end plate 144, the second liquid supply pipeline P7, and the second liquid discharge pipeline P8 according to the various embodiments of the present disclosure. As shown in FIG. 4A, the second liquid discharge pipeline P8 includes a transparent pipeline 410 that is substantially horizontal. In other words, at least a portion of the second liquid discharge pipeline P8 is transparent in the horizontal direction. In some embodiments, the transparent pipeline may be marked with a scale 412. Please refer to the embodiments of FIG. 3A for the embodiments and effects of FIG. 4A, which will not be described again. In some embodiments, the second liquid discharge pipeline P8 includes a non-horizontal transparent pipeline. For example, as shown in FIG. 4B, the second liquid discharge pipeline P8 includes a substantially vertical transparent pipeline 430. In other words, at least a portion of the second liquid discharge pipeline P8 is transparent in the vertical direction, but the present disclosure is not limited thereto. Please refer to the embodiments of FIG. 3B for the embodiments and effects of FIG. 4B, which will not be described again.

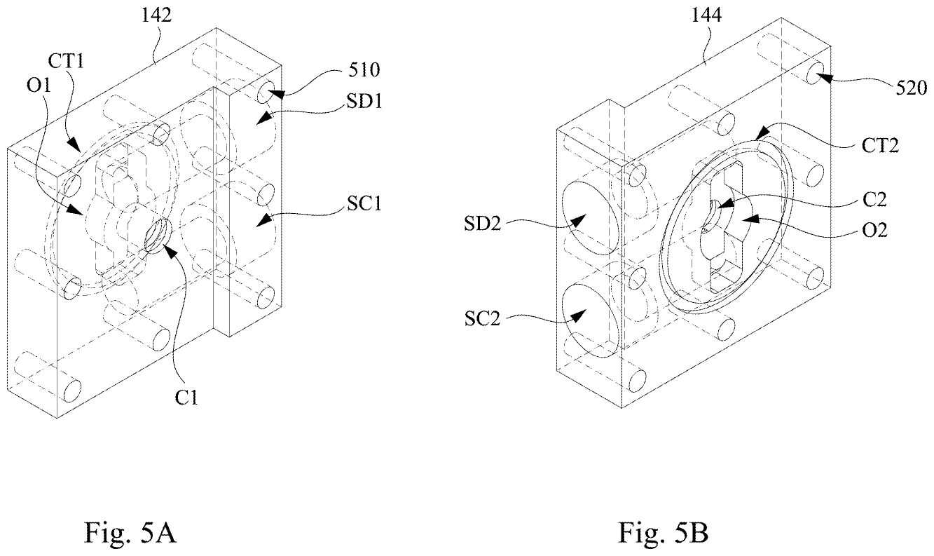

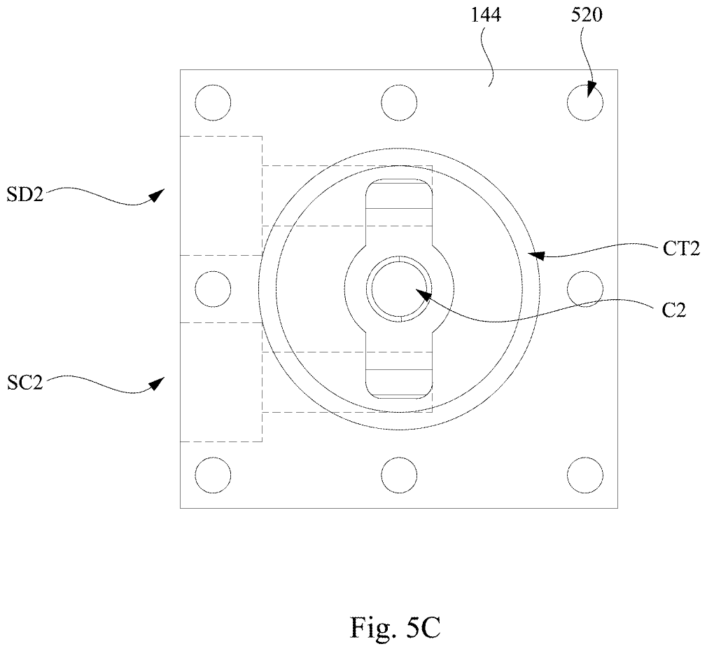

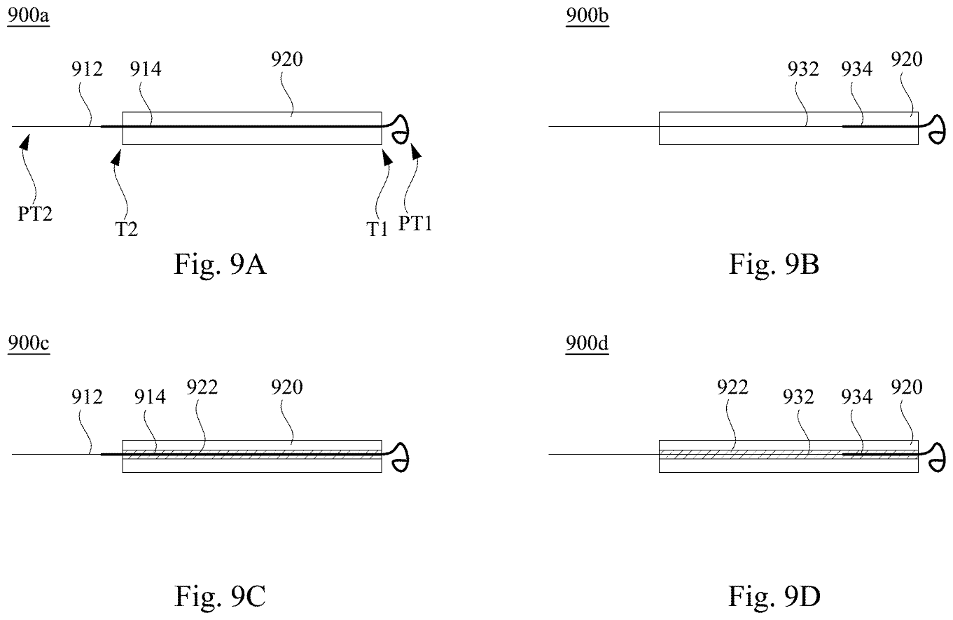

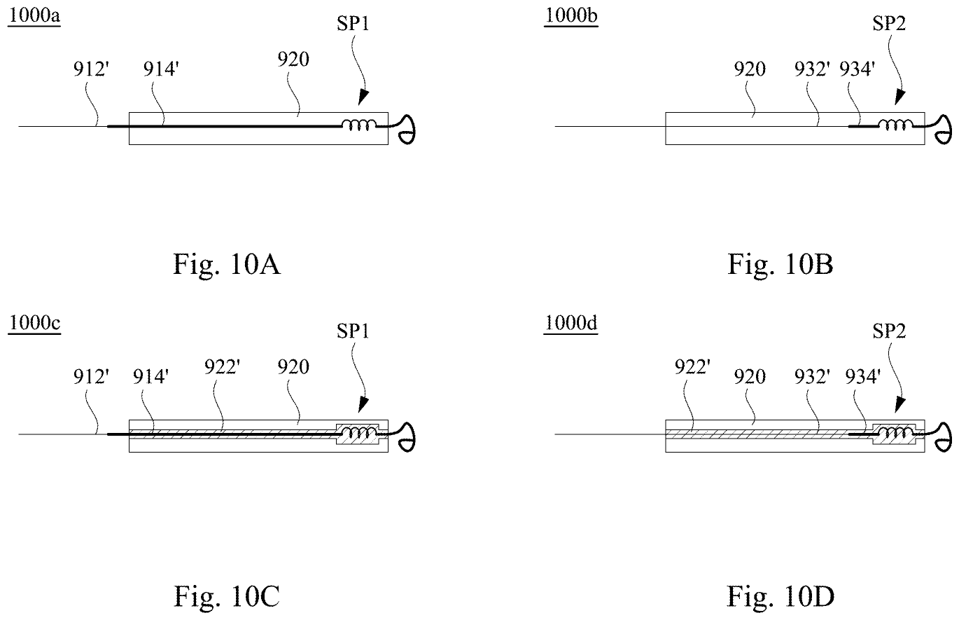

FIG. 5A is a perspective view of the positive end plate 142 according to the various embodiments of the present disclosure. The positive end plate 142 defines a first chamber C1. The positive electrolyte supply channel SC1 and the positive electrolyte discharge channel SD1 respectively penetrates through the positive end plate 142 to communicate with the first chamber C1. Please refer to FIG. 2A and FIG. 5A at the same time. The positive electrode element 210 penetrates through the positive end plate 142 and corresponds to the first chamber C1. In other words, the positive electrode element 210 is positioned in the first chamber C1. The positive electrode element 210 includes a first electrode rod (not shown) and a first signal transmission portion 212 that are connected. The positive end plate 142 has the first outer surface S1 away from the first chamber C1, and the first signal transmission portion 212 protrudes from the first outer surface S1. The embodiments of the positive electrode element 210 will be further described in the subsequent FIG. 9A to FIG. 10D.

FIG. 5B is a perspective view of the negative end plate 144 according to the various embodiments of the present disclosure. FIG. 5C is a side view of the negative end plate 144 according to the various embodiments of the present disclosure. The negative end plate 144 defines second chamber C2. The negative electrolyte supply channel SC2 and the negative electrolyte discharge channel SD2 respectively penetrate through the negative end plate 144 to communicate with the second chamber C2. Please refer to FIG. 2B and FIG. 5B at the same time. The negative electrode element 220 penetrates through the negative end plate 144 and corresponds to the second chamber C2. In other words, the negative electrode element 220 is positioned in the second chamber C2. The negative electrode element 220 includes a second electrode rod (not shown) and a second signal transmission portion 222 that are connected. The negative end plate 144 has the second outer surface S2 away from the second chamber C2, and the second signal transmission portion 222 protrudes from the second outer surface S2. The embodiments of the negative electrode element 220 will be further described in the subsequent FIG. 9A to FIG. 10D. In addition, please directly refer to the side view of the negative end plate 144 in FIG. 5C for the side view of the positive end plate 142, which will not be described again.

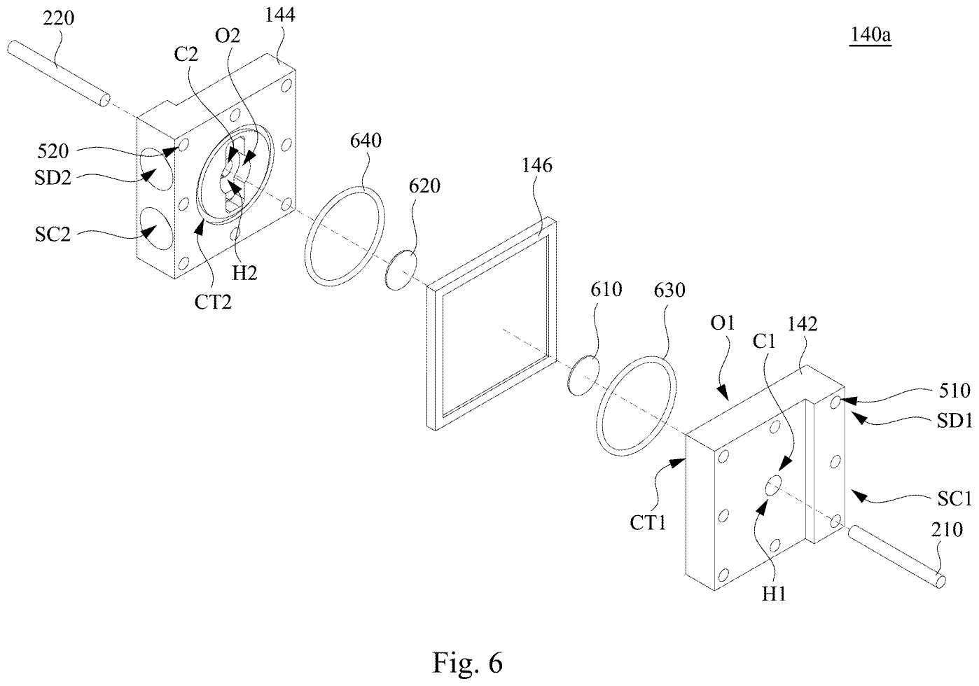

FIG. 6 to FIG. 8 are exploded schematic diagrams of a battery monitoring unit of a battery monitoring device according to the various embodiments of the present disclosure. As shown in FIG. 6, the battery monitoring unit 140a includes the positive end plate 142, the positive electrolyte supply channel SC1, the positive electrolyte discharge channel SD1, the positive electrode element 210, the negative end plate 144, the negative electrolyte supply channel SC2, the negative electrolyte discharge channel SD2, the negative electrode element 220 and the separator 146. The separator 146 is disposed between the first chamber C1 of the positive end plate 142 and the second chamber C2 of the negative end plate 144. Please refer to FIG. 2A, FIG. 5A, and FIG. 6 at the same time. When the positive electrode element 210 and the positive end plate 142 are assembled, the positive electrode element 210 penetrates through the positive electrode element mounting hole H1 of the positive end plate 142 and corresponds to the first chamber C1. In some embodiments, the positive electrode element 210 is directly fixed in the positive electrode element mounting hole H1. For example, the positive electrode element 210 is directly adhesively fixed or welded in the positive electrode element mounting hole H1. However, the present disclosure is not limited thereto. In addition, in some embodiments, as shown in FIG. 3A and FIG. 6, a screw 320 is screwed in the screw fixing hole 510 of the positive end plate 142 and the screw fixing hole 520 of the negative end plate 144, so that the positive end plate 142, the separator 146, and the negative end plate 144 groups are assembled and fixed together. In some embodiments, a nut (not shown) corresponding to the screw 320 is disposed on the outside of the negative end plate 144. Please refer to FIG. 2A, FIG. 5B, and FIG. 6 at the same time. When the negative electrode element 220 and the negative end plate 144 are assembled, the negative electrode element 220 penetrates through a negative electrode element mounting hole H2 of the negative end plate 144 and corresponds to the second chamber C2. In some embodiments, the negative electrode element 220 is directly adhesively fixed in the negative electrode element mounting hole H2, but the present disclosure is not limited thereto. In addition, in some embodiments, as shown in FIG. 4A and FIG. 6, a screw 420 is screwed in the screw fixing hole 520 of the negative end plate 144 and the screw fixing hole 510 of the positive end plate 142 to assemble and fix the negative end plate 144, the separator 146, and the positive end plate 142 together. In some embodiments, a nut (not shown) corresponding to the screw 420 is disposed on the outside of the positive end plate 142.

Please continue to refer to FIG. 6. In some embodiments, the battery monitoring unit 140a further includes a first conductive sheet 610 and a second conductive sheet 620. The first conductive sheet 610 is disposed between the separator 146 and the positive electrode element 210. The second conductive sheet 620 is disposed between the separator 146 and the negative electrode element 220. In some embodiments, the materials of the first conductive sheet 610 and the second conductive sheet 620 include graphite, carbon nanotubes, graphene, carbon black, carbon fiber, activated carbon, hollow carbon, soft carbon, hard carbon, or combinations thereof. The above-mentioned conductive sheets can reduce the impedance to more accurately measure the open circuit voltage of the battery monitoring unit 140a. In other embodiments, the battery monitoring unit 140a is not provided with the first conductive sheet 610 and the second conductive sheet 620. In some embodiments, the battery monitoring unit 140a further includes a first ring groove CT1, a first elastic sealing element 630, a second ring groove CT2, and a second elastic sealing element 640. As shown in FIG. 5A and FIG. 6, the first chamber C1 has a first opening O1 facing the separator 146, the first ring groove CT1 surrounds the first opening O1, and the first elastic sealing element 630 is disposed in the first ring groove CT1. As shown in FIG. 5B and FIG. 6, the second chamber C2 has a second opening O2 facing the separator 146, the second ring groove CT2 surrounds the second opening O2, and the second elastic sealing element 640 is disposed in the second ring groove CT2. When all the components shown in FIG. 6 are installed together, the above-mentioned elastic sealing elements can prevent electrolyte leakage. In some embodiments, the first elastic sealing element 630 and the second elastic sealing element 640 are sealing rings. In other embodiments, the battery monitoring unit 140a is not provided with the first ring groove CT1, the first elastic sealing element 630, the second ring groove CT2, and the second elastic sealing element 640.

In some embodiments, the battery monitoring unit 140a does not include a current collector plate, a bipolar plate, or a combination thereof. For example, no current collecting plate, bipolar plate, or combination thereof is provided between the separator 146 and the positive end plate 142, and no current collecting plate, bipolar plate, or combination thereof is provided between the separator 146 and the negative end plate 144. In some embodiments, the positive end plate 142 and the negative end plate 144 directly contact the separator 146. The battery monitoring unit 140a of the present disclosure has a simple structural design, so the process reliability and service life of the battery monitoring device can be improved, and the reproducibility of measuring battery capacity can be improved.

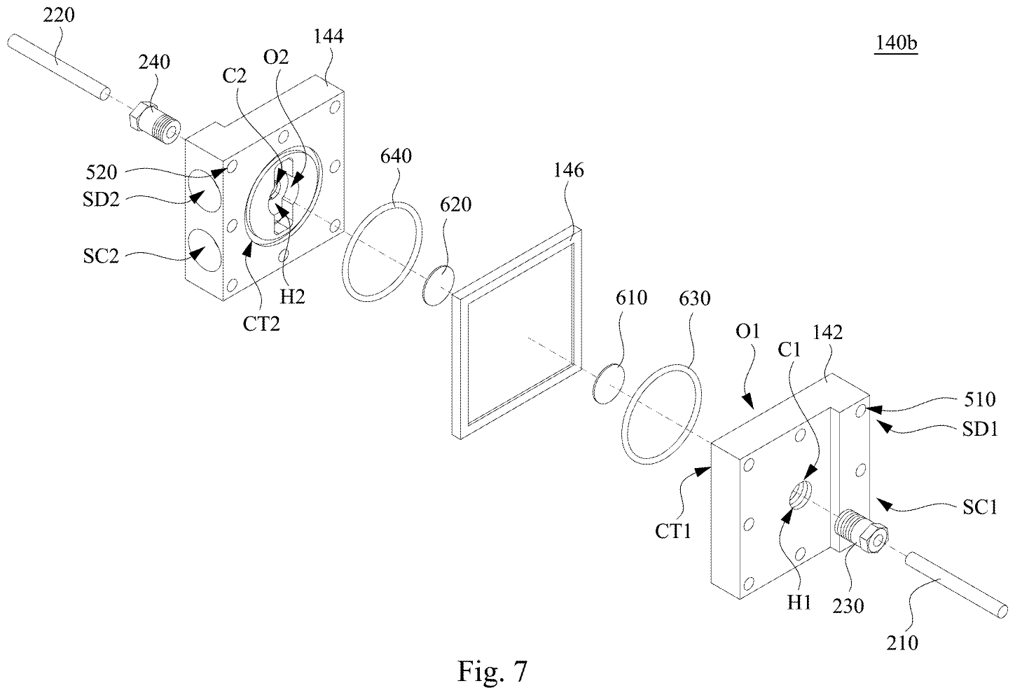

Please refer to FIG. 2A and FIG. 7. In some embodiments, the battery monitoring unit 140b further includes a first fixing component 230 and a second fixing component 240. The positive electrode element 210 is assembled with the first fixing component 230. Specifically, the positive electrode element 210 penetrates through the first fixing component 230 and is directly fixed to the first fixing component 230. For example, the positive electrode element 210 is directly adhesively fixed or welded to the first fixing component 230, but is not limited to this. The positive electrode element 210 is detachably fixed to the positive end plate 142 by the first fixing component 230 so that it can be disassembled from the positive end plate 142. The negative electrode element 220 is assembled with the second fixing component 240. Specifically, the negative electrode element 220 penetrates through the second fixing component 240 and is directly fixed to the second fixing component 240. For example, the negative electrode element 220 is directly adhesively fixed or welded to the second fixing component 240, but is not limited to this. The negative electrode element 220 is detachably fixed to the negative end plate 144 by the second fixing component 240 so that it can be disassembled from the negative end plate 144. For example, the first fixing component 230 and second fixing component 240 are fixing bases.

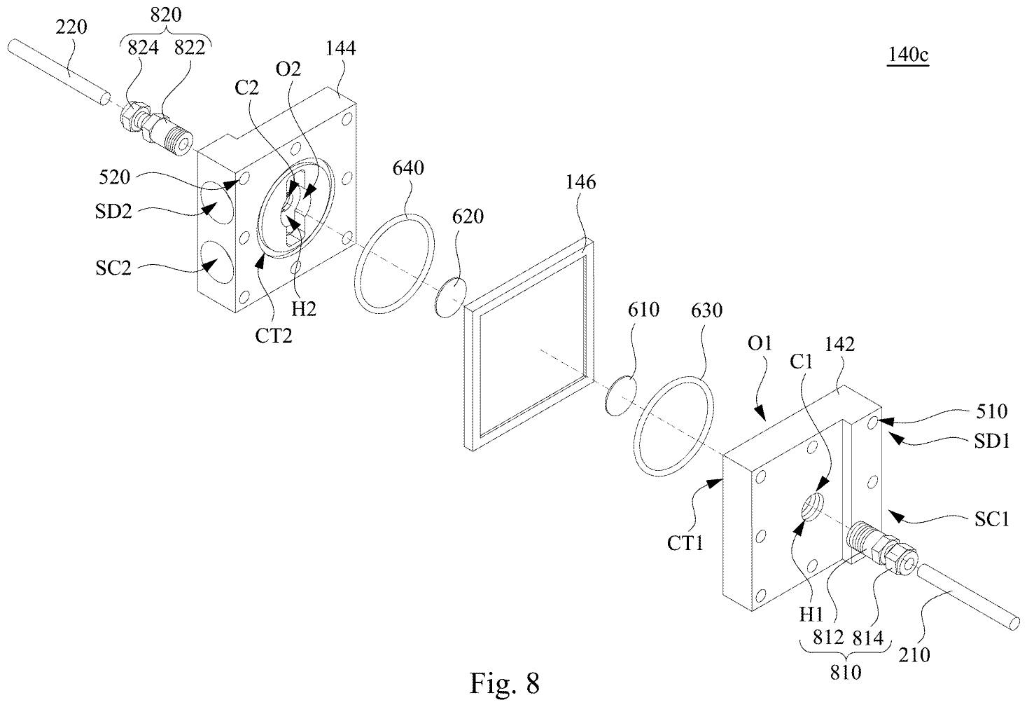

As shown in FIG. 8, in some embodiments, the battery monitoring unit 140c further includes a first fixing component 810 and a second fixing component 820. The positive electrode element 210 is detachably fixed to the positive end plate 142 by the first fixing component 810. Specifically, the first fixing component 810 includes a fixing base 812 and a connecting base 814. The fixing base 812 is detachably fixed to the positive end plate 142. The fixing base 812 is detachably assembled with the connecting base 814, and the positive electrode element 210 is detachably assembled with the connecting base 814, so it can be easily replaced. The hole in the connecting base 814 can compress the positive electrode element 210 when the positive electrode element 210 is inserted. The negative electrode element 220 is detachably fixed to the negative end plate 144 by the second fixing component 820. Specifically, the second fixing component 820 includes a fixing base 822 and a connecting base 824 that are connected. The fixing base 822 is detachably fixed to the negative end plate 144. The fixing base 822 is detachably assembled with the connecting base 824, and the negative electrode element 220 is detachably assembled with the connecting base 824, so it can be easily replaced. The hole in the connecting base 824 can compress the negative electrode element 220 when the negative electrode element 220 is inserted. The positive electrode element 210 and the negative electrode element 220 of the present disclosure are removable, so the convenience of use can be improved.

Please refer to FIG. 2A, FIG. 2B, FIG. 9A to FIG. 9D, and FIG. 10A to FIG. 10D. FIG. 9A to FIG. 9D and FIG. 10A to FIG. 10D are schematic cross-sectional views of electrode elements for the battery monitoring device MD according to the various embodiments of the present disclosure. The electrode elements shown in FIG. 9A to FIG. 9D and FIG. 10A to FIG. 10D can be used as the positive electrode element 210 of the battery monitoring unit 140 of FIG. 2A or the negative electrode element 220 of the battery monitoring unit 140 of FIG. 2B.

As shown in FIG. 9A, the electrode element 900a includes a signal transmission portion 912, an electrode rod 914, and an insulation tube 920. The electrode rod 914 is connected to the signal transmission portion 912. The signal transmission portion 912 is configured to connect with the voltage measurement unit to transmit signals. The electrode rod 914 is configured to measure the open circuit voltage of the battery monitoring device MD. The insulation tube 920 covers a portion of the electrode rod 914. More specifically, a portion of the electrode rod 914 is positioned in the tubular hole of the insulation tube 920. In other words, a portion of the electrode rod 914 is embedded in the insulation tube 920. The insulation tube 920 has a first end T1 and a second end T2, and the first end T1 and the second end T2 are opposite to each other. The electrode rod 914 has a first protruding portion PT1 positioned outside the first end T1, and the signal transmission portion 912 has a second protruding portion PT2 positioned outside the second end T2. The insulation tube 920 can prevent electrolyte leakage, thereby improving the reliability of battery monitoring components. In some embodiments, the electrode rod 914 has a straight shape. In some embodiments, the first protruding portion PT1 has a non-straight shape, so the first protruding portion PT1 can provide a larger area in contact with the electrolyte, prevent puncturing of the separator, and facilitate a reduction in component size. In some embodiments, the non-straight shape is a curved shape, a spiral shape, a coiled shape, or combinations thereof. In some embodiments, the first protruding portion PT1 is a coiled part. In other embodiments, the first protruding portion PT1 has a straight shape (not shown). In some embodiments, the material of the electrode rod 914 includes carbon materials, carbon composite materials, gold, platinum, or combinations thereof. For example, the carbon materials include graphite, carbon nanotubes, graphene, carbon black, carbon fibers, activated carbon, hollow carbon, soft carbon, hard carbon, or combinations thereof. For example, the carbon composite materials include sulfur-carbon composite materials, silicon-carbon composite materials, carbon/carbon composite materials, or combinations thereof. Compared with carbon materials and carbon composite materials, platinum has higher stability, so the measurement reproducibility is better. In some embodiments, the material of the signal transmission portion 912 includes copper, aluminum, nickel, silver, gold, platinum, alloys of any of the above metals, or combinations thereof. In some embodiments, the electrode rod 914 and the signal transmission portion 912 include different materials. In some embodiments, the signal transmission portion 912 is a copper wire, and the electrode rod 914 is a carbon rod or a platinum rod (white gold rod). In some embodiments, the material of the insulation tube 920 includes polyethylene, polypropylene, polyvinyl chloride, or combinations thereof.

As shown in FIG. 9B, the electrode element 900b includes a signal transmission portion 932, an electrode rod 934, and an insulation tube 920. The electrode rod 934 is configured to measure the open circuit voltage of the battery monitoring device MD. The difference between FIG. 9A and FIG. 9B is that the insulation tube 920 of FIG. 9B further covers a portion of the signal transmission portion 932. Specifically, the insulation tube 920 of FIG. 9B covers a portion of the signal transmission portion 932 and a portion of the electrode rod 934 at the same time. If the ductility of the signal transmission portion 932 is higher than the ductility of the electrode rod 934, compared with the electrode element 900a of FIG. 9A, the electrode element 900b of FIG. 9B can further reduce the probability of fracture of the electrode rod 934. Compared with the electrode element 900a, the usage amount of the electrode rod 934 of the electrode element 900b can be further reduced.

As shown in FIG. 90, the electrode element 900c includes a signal transmission portion 912, an electrode rod 914, an insulation tube 920, and an inner protective film 922. The inner protective film 922 covers a portion of the electrode rod 914 and is positioned between the electrode rod 914 and the insulation tube 920. The difference between FIG. 9A and FIG. 9C is that the electrode element 900c of FIG. 9C further includes the inner protective film 922. The inner protective film 922 may be formed of insulation adhesive that can resist acid and alkali, such as polyethylene glue, polypropylene glue, polyvinyl chloride glue, or combinations thereof. In some embodiments, the materials of the inner protective film 922 and the insulation tube 920 independently include polyethylene, polypropylene, polyvinyl chloride, or combinations thereof. In some embodiments, the inner protective film 922 and the insulation tube 920 include the same materials, such as polyvinyl chloride. In some embodiments, the inner protective film 922 and the insulation tube 920 include different materials.

As shown in FIG. 9D, the electrode element 900d includes a signal transmission portion 932, an electrode rod 934, an insulation tube 920, and an inner protective film 922. The inner protective film 922 covers a portion of the electrode rod 934 and a portion of the signal transmission portion 932. The inner protective film 922 is positioned between the electrode rod 934 and the insulation tube 920 and between the signal transmission portion 932 and the insulation tube 920. The difference between FIG. 9B and FIG. 9D is that the electrode element 900d of FIG. 9D further includes the inner protective film 922.

As shown in FIG. 10A, the electrode element 1000a includes a signal transmission portion 912′, an electrode rod 914′, and an insulation tube 920. The electrode rod 914′ is configured to measure the open circuit voltage of the battery monitoring device MD. The electrode rod 914′ is connected to the signal transmission portion 912′, and has a non-straight part SP1 covered by the insulation tube 920. In some embodiments, the non-straight part SP1 has a curved shape, a spiral shape, a coiled shape, or combinations thereof. The difference between FIG. 9A and FIG. 10A is that the electrode rod 914′ of FIG. 10A has the non-straight part SP1. When the electrode element 1000a is disposed in a monitoring battery element, the non-straight part SP1 can make the electrolyte in the chamber less likely to leak to the outside, so the electrode element 1000a can meet the requirements of high-voltage operation environments. Moreover, the non-straight part SP1 allows the electrode rod 914′ to be firmly embedded in the insulation tube 920.

As shown in FIG. 10B, the electrode element 1000b includes a signal transmission portion 932′, an electrode rod 934′, and an insulation tube 920. The electrode rod 934′ is configured to measure the open circuit voltage of the battery monitoring device MD. The electrode rod 934′ has a non-straight part SP2. In some embodiments, the non-straight part SP2 has a curved shape, a spiral shape, a coiled shape, or combinations thereof. The difference between FIG. 10A and FIG. 10B is that the insulation tube 920 of FIG. 10B covers a portion of the signal transmission portion 932′. As shown in FIG. 10C, the electrode element 1000c includes a signal transmission portion 912′, an electrode rod 914′, an insulation tube 920, and an inner protective film 922′. The inner protective film 922′ covers a portion of the electrode rod 914′ and is positioned between the electrode rod 914′ and the insulation tube 920. The difference between FIG. 10A and FIG. 10C is that the electrode element 1000c of FIG. 10C further includes the inner protective film 922′. As shown in FIG. 10D, the electrode element 1000d includes a signal transmission portion 932′, an electrode rod 934′, an insulation tube 920, and an inner protective film 922′. The inner protective film 922′ covers a portion of the electrode rod 934′ and a portion of the signal transmission portion 932′. The inner protective film 922′ is positioned between the electrode rod 934′ and the insulation tube 920 and between the signal transmission portion 932′ and the insulation tube 920. The difference between FIG. 10B and FIG. 10D is that the electrode element 1000d of FIG. 10D further includes the inner protective film 922′.

Next, the present disclosure will provide several manufacturing methods for the electrode element of the battery monitoring device. Although a series of operations or steps are used below to describe the method disclosed herein, an order of these operations or steps should not be construed as a limitation to the present disclosure. For example, some operations or steps may be performed in a different order, and/or other steps may be performed at the same time. In addition, it is not necessary to perform all of the operations, steps, and/or features shown to achieve the embodiments of the present disclosure. In addition, each operation or step described herein may contain several sub-steps or actions.

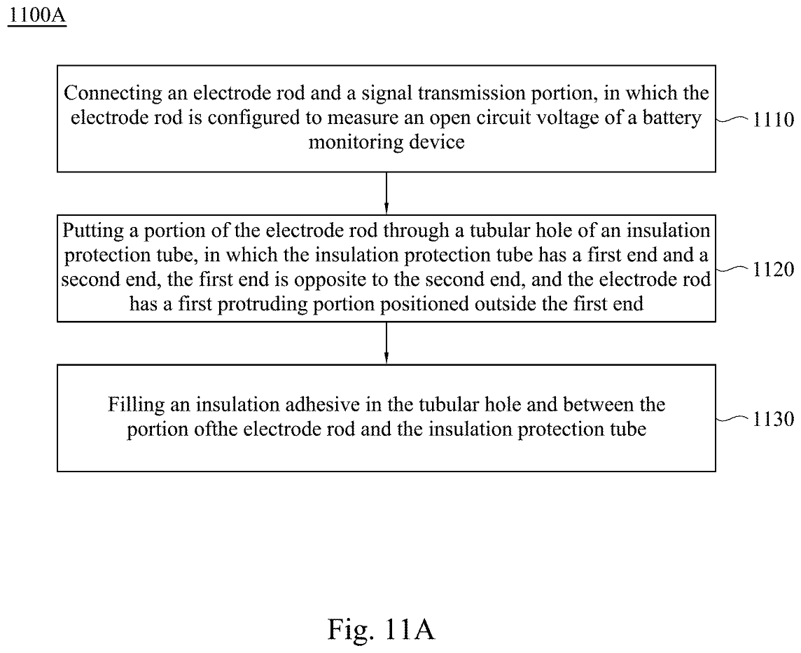

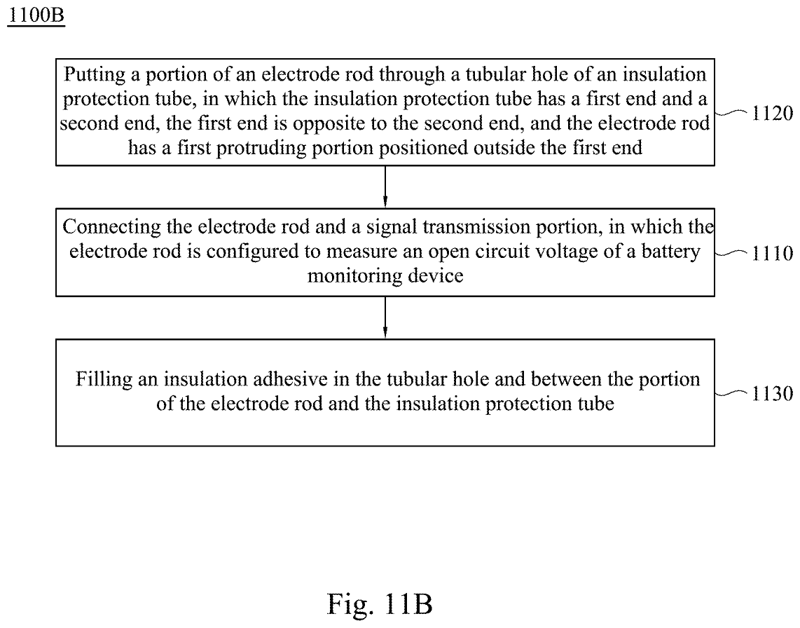

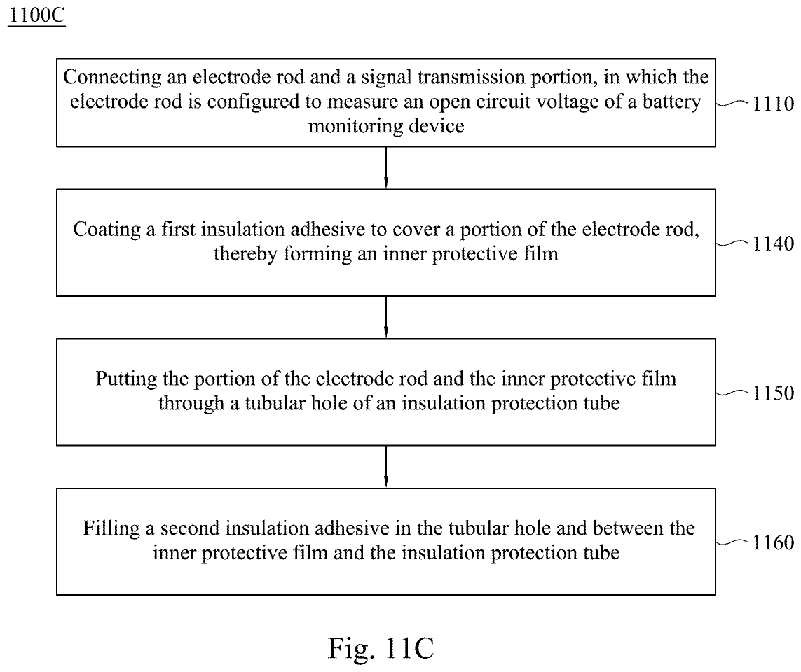

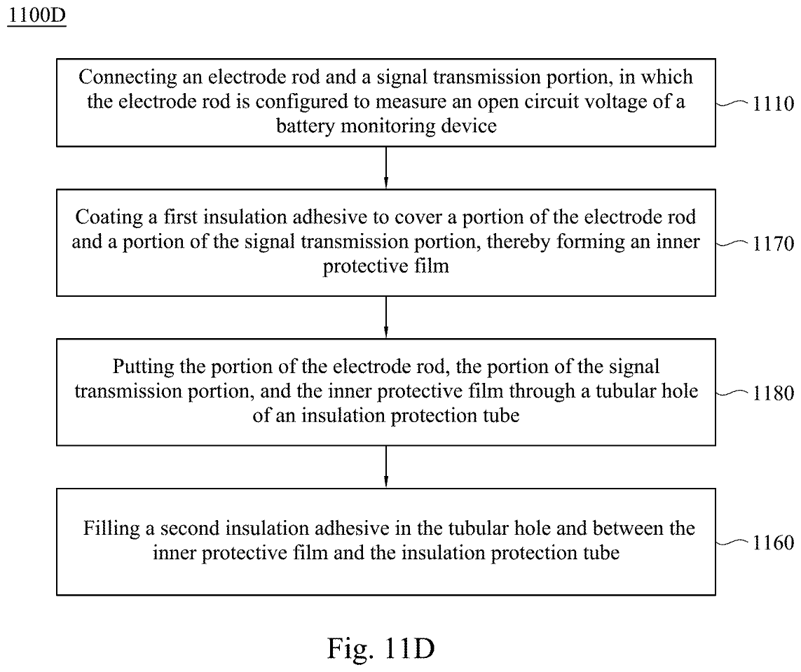

The present disclosure provides a manufacturing method for an electrode element of a battery monitoring device. Please refer to both FIG. 9A and FIG. 11A. FIG. 11A is a flow chart of a manufacturing method 1100A for an electrode element of a battery monitoring device according to the various embodiments of the present disclosure. The manufacturing method 1100A includes operation 1110, operation 1120, and operation 1130 that are executed sequentially. In operation 1110, the electrode rod 914 is connected to the signal transmission portion 912, in which the electrode rod 914 is configured to measure the open circuit voltage of the battery monitoring device MD, and the signal transmission portion 912 is configured to connect to the voltage measurement unit 148 to transmit signals. In some embodiments, connecting the electrode rod 914 to the signal transmission portion 912 is performed by welding. In operation 1120, a portion of the electrode rod 914 is put through the tubular hole of the insulation tube 920, in which the insulation tube 920 has the first end T1 and the second end T2, the first end T1 is opposite to the second end T2, and the electrode rod 914 has the first protruding portion PT1 positioned outside the first end T1, and the signal transmission portion 912 has the second protruding portion PT2 positioned outside the second end T2. In operation 1130, insulation adhesive is filled in the tubular hole and between the portion of the electrode rod 914 and the insulation tube 920 to fill the gap between the electrode rod 914 and the insulation tube 920, thereby achieving the effect of preventing electrolyte leakage. The present disclosure provides another manufacturing method for an electrode element of a battery monitoring device. Please refer to both FIG. 9A and FIG. 11B. The manufacturing method 1100B includes operation 1120, operation 1110, and operation 1130 that are executed sequentially. After putting a portion of the electrode rod 914 through the tubular hole of the insulation tube 920, the electrode rod 914 and the signal transmission portion 912 are connected. In some embodiments, the insulation adhesive includes polyethylene glue, polypropylene glue, polyvinyl chloride glue, polytetrafluoroethylene glue, or combinations thereof.

The present disclosure provides a manufacturing method for an electrode element of a battery monitoring device. Please refer to FIG. 9B and FIG. 11A at the same time. In operation 1110, the electrode rod 934 and the signal transmission portion 932 are connected, in which the electrode rod 934 is configured to measure the open circuit voltage of the battery monitoring device MD, and the signal transmission portion 932 is configured to connect to the voltage measurement unit 148 to transmit signals. In operation 1120, a portion of the electrode rod 934 is put through the tubular hole of the insulation tube 920. The manufacturing method 1100A further includes putting a portion of the signal transmission portion 932 through the tubular hole of the insulation tube 920. In operation 1130, insulation adhesive is filled in the tubular hole and between the portion of the electrode rod 934 and the insulation tube 920. The manufacturing method 1100A further includes filling the insulation adhesive between the portion of the signal transmission portion 932 and the insulation tube 920. Thereby, the gaps between the electrode rod 934, the signal transmission portion 932, and the insulation tube 920 are filled, thereby achieving the effect of preventing electrolyte leakage.

The present disclosure provides a manufacturing method for an electrode element of a battery monitoring device. Please refer to both FIG. 9C and FIG. 11C. FIG. 11C is a flow chart of a manufacturing method 1100C for an electrode element of a battery monitoring device according to the various embodiments of the present disclosure. The manufacturing method 1100C includes operation 1110, operation 1140, operation 1150, and operation 1160 that are executed sequentially. In operation 1110, the electrode rod 914 is connected to the signal transmission portion 912, in which the electrode rod 914 is configured to measure the open circuit voltage of the battery monitoring device MD, and the signal transmission portion 912 is configured to connect to the voltage measurement unit 148 to transmit signals. In operation 1140, first insulation adhesive is coated to cover a portion of the electrode rod 914 to form the inner protective film 922. In operation 1150, the portion of the electrode rod 914 and the inner protective film 922 are put through the tubular hole of the insulation tube 920. In operation 1160, second insulation adhesive is filled in the tubular hole and between the inner protective film 922 and the insulation tube 920 to fill the gaps, thereby achieving the effect of preventing electrolyte leakage. In some embodiments, the first insulation adhesive and the second insulation adhesive independently include polyethylene glue, polypropylene glue, polyvinyl chloride glue, polytetrafluoroethylene glue, or combinations thereof. In other implementations, operation 1140, operation 1150, operation 1110, and operation 1160 are executed sequentially. In other implementations, operation 1140, operation 1150, operation 1160, and operation 1110 are executed sequentially.

The present disclosure provides a manufacturing method for an electrode element of a battery monitoring device. Please refer to both FIG. 9D and FIG. 11D. FIG. 11D is a flow chart of a manufacturing method 1100D for an electrode element of a battery monitoring device according to the various embodiments of the present disclosure. The manufacturing method 1100D includes operation 1110, operation 1170, operation 1180, and operation 1160 that are executed sequentially. Please refer to the aforementioned embodiments for operation 1110, which will not be described again. In operation 1170, first insulation adhesive is coated to cover a portion of the electrode rod 934 and a portion of the signal transmission portion 932, thereby forming the inner protective film 922. In operation 1180, the portion of the electrode rod 934, the portion of the signal transmission portion 932, and the inner protective film 922 are put through the tubular hole of the insulation tube 920. In operation 1160, second insulation adhesive is filled in the tubular hole and between the inner protective film 922 and the insulation tube 920 to fill the gaps, thereby achieving the effect of preventing electrolyte leakage.

The electrode elements of FIG. 10A, FIG. 10B, FIG. 10C, and FIG. 10D can be manufactured with reference to the embodiments of FIG. 9A, FIG. 9B, FIG. 9C, and FIG. 9D respectively. The above-mentioned manufacturing methods of the electrode elements are simple and can improve the reliability of the electrode elements. Moreover, compared with the electrode element 1000a and the electrode element 1000c, the usage amount of the electrode rod 934′ of the electrode element 1000b or the electrode element 1000d can be further reduced.

The following describes the features of the present disclosure more specifically with reference to experimental examples. Although the following embodiments are described, the materials, their amounts and ratios, processing details, processing procedures, etc., may be appropriately varied without exceeding the scope of the present disclosure. Accordingly, the present disclosure should not be interpreted restrictively by the embodiments described below.

### Experimental Example: Battery Capacity Measurement of Flow Battery

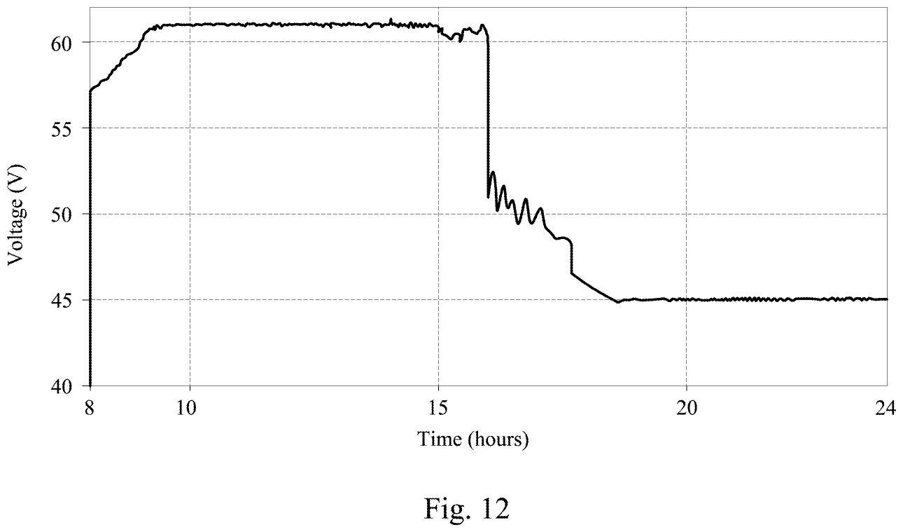

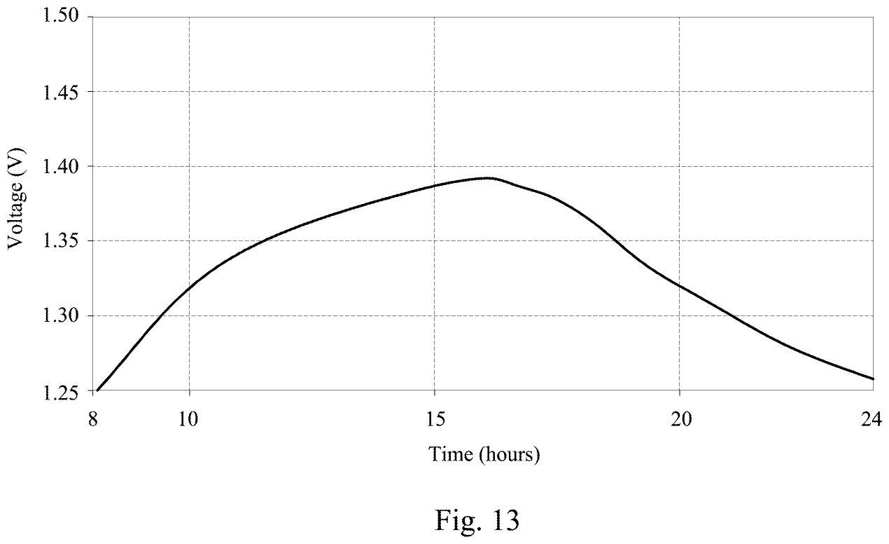

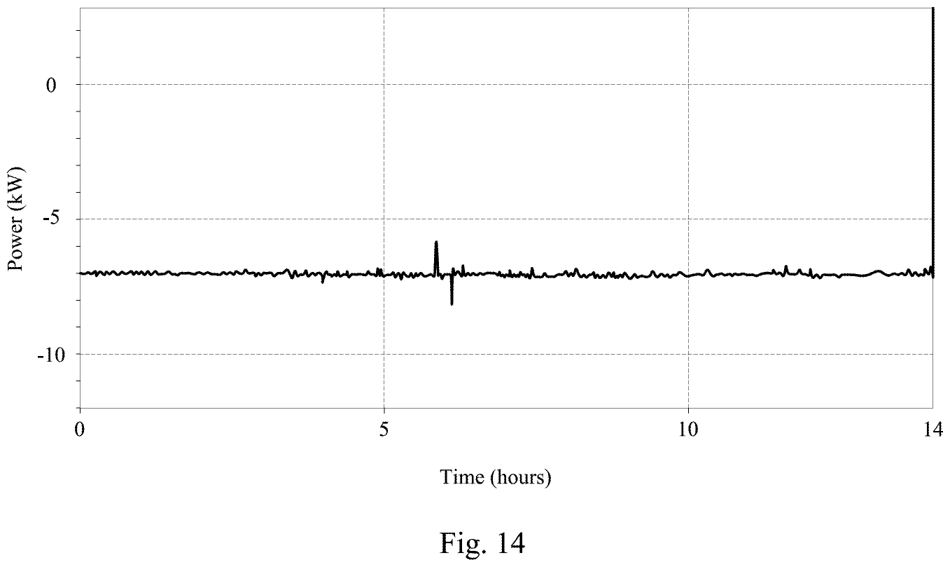

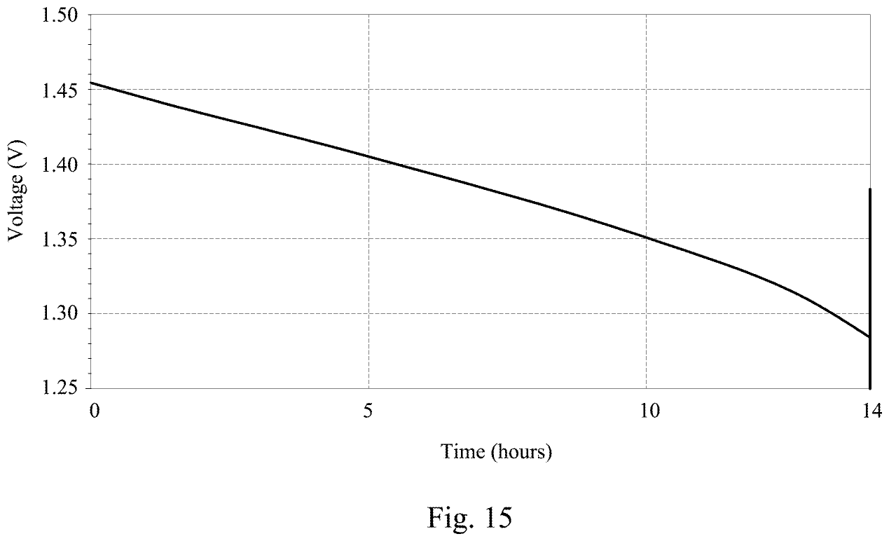

The flow battery system 100 shown in FIG. 1 was charged and discharged, in which the flow battery FB was a vanadium flow battery, and the battery monitoring unit 140 of the battery monitoring device MD was coupled to the positive electrolyte tank 120 through the first liquid supply pipeline P5 and the first liquid discharge pipeline P6 and was coupled to the negative electrolyte tank 130 through the second liquid supply pipeline P7 and the second liquid discharge pipeline P8. Please refer to FIG. 9C for the embodiment of the positive electrode element and the negative electrode element in the battery monitoring unit 140, in which the signal transmission portion 912 was a copper wire, the electrode rod 914 was a platinum rod, the inner protective film 922 was a polyvinyl chloride layer, and the insulation tube 920 was a polyvinyl chloride pipe. The battery monitoring unit 140 was externally connected to the voltage measurement unit 148 to measure the open circuit voltage of the battery monitoring unit 140. During the measurement, the electrolyte flow rate could be adjusted by the first valve V1 and/or the second valve V2. FIG. 12 is a voltage-time relationship diagram of the flow battery according to the various embodiments of the present disclosure. FIG. 13 is a voltage-time relationship diagram of the battery monitoring device according to the various embodiments of the present disclosure. When the load 150 changed during the discharge process, the voltage of the flow battery FB oscillates as shown in FIG. 12. However, as shown in FIG. 13, the voltage of the battery monitoring device MD is not affected by the load 150. FIG. 14 is a power-time relationship diagram of the flow battery according to the various embodiments of the present disclosure. FIG. 15 is a voltage-time relationship diagram of the battery monitoring device according to the various embodiments of the present disclosure. The battery capacity of the flow battery FB can be calculated from the power of the flow battery FB in FIG. 14 and the open circuit voltage of the battery monitoring device MD in FIG. 15.

According to the above, the present disclosure provides a flow battery system, a battery monitoring device for the flow battery system, an electrode element for the battery monitoring device, and a manufacturing method of the electrode element. The battery monitoring device of the present disclosure has a simple structural design, so its process reliability and service life can be improved, and the reproducibility of measuring battery capacity can be improved. When measuring the open circuit voltage, the voltage of the battery monitoring device is not affected by the load, so the user can accurately know the battery capacity of the flow battery. Therefore, the user can accurately control the charge and discharge of the flow battery, thereby achieving maximum battery capacity and extending the service life of the flow battery.

Although the present disclosure has been described in considerable detail with reference to certain embodiments, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover the modifications and variations of the present disclosure falling within the scope of the appended claims.

What is claimed is:

1. A battery monitoring device for a flow battery system, the battery monitoring device comprising:
a positive end plate defining a first chamber;
a positive electrolyte supply channel and a positive electrolyte discharge channel respectively penetrating through the positive end plate to communicate with the first chamber;
a positive electrode element penetrating through the positive end plate and corresponding to the first chamber, wherein the positive electrode element comprises a first electrode rod and a first signal transmission portion that are connected, the positive end plate has a first outer surface away from the first chamber, and the first signal transmission portion protrudes from the first outer surface;
a negative end plate defining a second chamber;
a negative electrolyte supply channel and a negative electrolyte discharge channel respectively penetrating through the negative end plate to communicate with the second chamber;
a negative electrode element penetrating through the negative end plate and corresponding to the second chamber, wherein the negative electrode element comprises a second electrode rod and a second signal transmission portion that are connected, the negative end plate has a second outer surface away from the second chamber, and the second signal transmission portion protrudes from the second outer surface; and
a separator disposed between the first chamber and the second chamber.

2. The battery monitoring device of claim 1, further comprising a first conductive sheet and a second conductive sheet, wherein the first conductive sheet is disposed between the separator and the positive electrode element, and the second conductive sheet is disposed between the separator and the negative electrode element.

3. The battery monitoring device of claim 1, further comprising a first ring groove, a first elastic sealing element, a second ring groove, and a second elastic sealing element, wherein the first chamber has a first opening facing the separator, the first ring groove surrounds the first opening, and the first elastic sealing element is disposed in the first ring groove, the second chamber has a second opening facing the separator, the second ring groove surrounds the second opening, and the second elastic sealing element is disposed in the second ring groove.

4. The battery monitoring device of claim 1, further comprising a first fixing component and a second fixing component, wherein the positive electrode element is detachably fixed to the positive end plate by the first fixing component, and the negative electrode element is detachably fixed to the negative end plate by the second fixing component.

5. The battery monitoring device of claim 1, wherein the positive electrode element further comprises a first insulation tube covering a portion of the first electrode rod, the first electrode rod has a first protruding portion protruding from the first insulation tube, the negative electrode element further comprises a second insulation tube covering a portion of the second electrode rod, and the second electrode rod has a second protruding portion protruding from the second insulation tube.

6. The battery monitoring device of claim 5, wherein at least one of the first protruding portion and the second protruding portion has a non-straight shape.

7. The battery monitoring device of claim 6, wherein the non-straight shape is a curved shape, a spiral shape, a coiled shape, or combinations thereof.

8. The battery monitoring device of claim 5, wherein the first insulation tube further covers a portion of the first signal transmission portion, and the second insulation tube further covers a portion of the second signal transmission portion.

9. The battery monitoring device of claim 5, wherein the first electrode rod has a first non-straight part covered by the first insulation tube, and the second electrode rod has a second non-straight part covered by the second insulation tube.

10. The battery monitoring device of claim 5, wherein the positive electrode element further comprises a first inner protective film covering a portion of the first electrode rod, the first inner protective film is positioned between the first electrode rod and the first insulation tube, the negative electrode element further comprises a second inner protective film covering a portion of the second electrode rod, and the second inner protective film is positioned between the second electrode rod and the second insulation tube.

11. A flow battery system, comprising:
a flow battery unit;
a positive electrolyte tank storing a positive electrolyte, wherein the positive electrolyte tank is coupled to the flow battery unit;
a negative electrolyte tank storing a negative electrolyte, wherein the negative electrolyte tank is coupled to the flow battery unit;
the battery monitoring device of claim 1;
a first liquid supply pipeline coupled to the positive electrolyte tank and communicating with the positive electrolyte supply channel;
a second liquid supply pipeline coupled to the negative electrolyte tank and communicating with the negative electrolyte supply channel;
a first liquid discharge pipeline connected to the positive electrolyte discharge channel and coupled to the positive electrolyte tank; and
a second liquid discharge pipeline connected to the negative electrolyte discharge channel and coupled to the negative electrolyte tank.

12. The flow battery system of claim 11, wherein the positive electrolyte tank is connected to the flow battery unit through a first main liquid supply pipeline, the negative electrolyte tank is connected to the flow battery unit through a second main liquid supply pipeline, the first main liquid supply pipeline communicates with the first liquid supply pipeline, the second main liquid supply pipeline communicates with the second liquid supply pipeline, pipeline diameters of the first main liquid supply pipeline and the second main liquid supply pipeline are respectively greater than pipeline diameters of the first liquid supply pipeline and the second liquid supply pipeline.

13. The flow battery system of claim 11, further comprising at least one valve disposed on the first liquid supply pipeline, the second liquid supply pipeline, the first liquid discharge pipeline, the second liquid discharge pipeline, or combinations thereof.

14. The flow battery system of claim 11, wherein at least one of the first liquid discharge pipeline and the second liquid discharge pipeline comprises a transparent pipeline.

15. The flow battery system of claim 14, wherein the transparent pipeline is substantially horizontal.

16. The flow battery system of claim 14, wherein the transparent pipeline is non-horizontal.

17. An electrode element for a battery monitoring device, comprising:
a signal transmission portion;
an electrode rod connected to the signal transmission portion, wherein the electrode rod is configured to measure an open circuit voltage of the battery monitoring device; and
an insulation tube covering a portion of the electrode rod, wherein the insulation tube has a first end and a second end, the first end is opposite to the second end, and the electrode rod has a first protruding portion positioned outside the first end, and the signal transmission portion has a second protruding portion positioned outside the second end.

18. The electrode element of claim 17, wherein a material of the electrode rod comprises a carbon material, a carbon composite material, gold, platinum, or combinations thereof.

19. The electrode element of claim 17, wherein a material of the signal transmission portion comprises copper, aluminum, nickel, silver, gold, platinum, alloys of any of the above metals, or combinations thereof.

20. The electrode element of claim 17, wherein the first protruding portion has a non-straight shape.

21. The electrode element of claim 20, wherein the non-straight shape is a curved shape, a spiral shape, a coiled shape, or combinations thereof.

22. The electrode element of claim 17, wherein the insulation tube further covers a portion of the signal transmission portion.

23. The electrode element of claim 17, wherein the electrode rod has a non-straight part covered by the insulation tube.

24. The electrode element of claim 17, further comprising an inner protective film covering a portion of the electrode rod, wherein the inner protective film is positioned between the portion of the electrode rod and the insulation tube.

25. The electrode element of claim 24, wherein materials of the inner protective film and the insulation tube independently comprise polyethylene, polypropylene, polyvinyl chloride, or combinations thereof.

26. A manufacturing method for an electrode element of a battery monitoring device, comprising:
connecting an electrode rod to a signal transmission portion, wherein the electrode rod is configured to measure an open circuit voltage of the battery monitoring device; and
putting a portion of the electrode rod through a tubular hole of an insulation tube, wherein the insulation tube has a first end and a second end, the first end is opposite to the second end, and the electrode rod has a first protruding portion positioned outside the first end.

27. The manufacturing method of claim 26, further comprising: after putting the portion of the electrode rod through the tubular hole of the insulation tube, filling insulation adhesive into the tubular hole and between the portion of the electrode rod and the insulation tube.

28. The manufacturing method of claim 26, further comprising before putting the portion of the electrode rod through the tubular hole of the insulation tube, coating the portion of the electrode rod or the portion of the electrode rod and a portion of the signal transmission portion with insulation adhesive.

29. The manufacturing method of claim 26, further comprising putting a portion of the signal transmission portion through the tubular hole of the insulation tube.

30. The manufacturing method of claim 26, wherein after putting the portion of the electrode rod through the tubular hole of the insulation tube, connecting the electrode rod and the signal transmission portion, wherein the signal transmission portion has a second protruding portion positioned outside the second end.
